(19) United States
(12) Patent Application Publication
(10) Pub. No.: US 2012/0170511 A1
(43) Pub. Date: Jul. 5, 2012

(54) METHOD AND APPARATUS FOR PROVIDING DATA CONNECTIVITY IN A LOCAL WIRELESS TELEPHONY SYSTEM

(75) Inventor: STEVEN RODNEY, PLANTATION, FL (US)

(73) Assignee: OPENPEAK, INC., BOCA RATON, FL (US)

(21) Appl. No.: 12/980,523

(22) Filed: Dec. 29, 2010

(51) Int. Cl. H04W 4/00

(52) U.S. Cl. 370/328

(57) ABSTRACT

In an embodiment, a base station of a local wireless telephony system routes data between a handset on a first link and a data network-connected device on a second link of a local wireless telephony interface to provide data service to the handset.

### FIELD OF THE INVENTION

The subject matter described herein relates generally to local wireless telephony systems, and more particularly to local wireless telephony systems that support data service in addition to telephony service.

### BACKGROUND OF THE INVENTION

The design of telephony handsets has been evolving to include more and more data service and general computing ability. This has been particularly visible in mobile cellular telephony handsets where so called “smart” phones are able to run programs that have nothing to do with telephony, but are useful and convenient on a mobile phone platform. Similarly, non-mobile handsets, such as residential equipment, have also been increasingly designed to utilize data services and perform non-telephony functions for user convenience.

As the wireless paradigm has been widely accepted, it is very common to find cordless telephone handsets for use in residential and similar settings. A cordless phone system uses a base station which connects to a telephone service, such as a conventional Plain Old Telephone Service (POTS), Integrated Services Digital Network (ISDN), or other such telephony service. The base station provides a local wireless telephony interface, which is a radio interface, to wireless-enabled handsets so that the handsets can access the telephony service. It has become increasingly common to design base stations that can directly access data networks to provide data services to handsets associated with the base station. However, this adds considerable cost and complexity to the base station. Therefore, there is a need to provide access to data services while avoiding the cost and complexity of having data service access components in the base station.

### SUMMARY OF THE INVENTION

An embodiment includes a method of providing data service to remote telephony devices at a telephony base station, which is commenced upon receiving a non-telephony data network access request from the remote telephony device at the telephony base station over a first link of a local wireless telephony interface. The method further commences by forwarding the non-telephony data network access request to a broadband-enabled device over a second link of the local wireless telephony interface responsive to receiving the non-telephony data network access request. The base station then commences routing data traffic between the remote telephony device and the broadband-enabled device at the telephony base station using the first and second links of the local wireless telephony interface for a data session established responsive to the non-telephony data network request.

Another embodiment includes a telephony base station of a local wireless telephony system including a transceiver that provides a local wireless telephony interface, a telephony network adapter that interfaces with a telephony network for telephony service, and a registry that maintains registration of devices that communicate with the telephony base station over the local wireless telephony interface, including at least a first remote telephony device and a broadband-enabled device. Responsive to a non-telephony data network access request from the first remote telephony device, the telephony base station routes data traffic between the remote telephony device and the broadband-enabled device at the telephony base station over the local wireless telephony interface.

A further embodiment includes a method of providing data service access in a local wireless telephony system. The method can commence by registering a broadband-enabled device with a base station of the local wireless telephony system over a local wireless telephony interface established by the base station. The method can further commence by receiving a request from the base station at the broadband-enabled device to provide data service for a remote telephony device over a first link of the local wireless telephony interface in which the remote telephony device is connected to the base station over a second link of the local wireless telephony interface. The method can further include routing data between a data network via a data connection and the base station via the first link at the broadband enabled device for a data session between the remote telephony device and an entity in the data network.

Another embodiment can include a broadband-enabled device that includes a controller responsive to instruction code of a memory of the broadband-enabled device, a local wireless telephony adapter operably coupled to the controller, and a data network adapter operably coupled to the controller. The broadband-enabled device can route data between a base station of a local wireless telephony system via the local wireless telephony adapter and a network entity of a data network via the data network adapter responsive to a request from the base station.

### BRIEF DESCRIPTION OF THE DRAWINGS

There are shown in the drawings, embodiments which are presently preferred, it being understood, however, that the subject matter herein is not limited to the precise arrangements and instrumentalities shown.

FIG. 1 shows a block schematic diagram of a base station for a local wireless telephony system, in accordance with an embodiment;

FIG. 2 shows a system schematic of a local wireless telephony system where data service is relayed to the base station by an associated broadband-enabled device, in accordance with an embodiment;

FIG. 3 shows a channel diagram for one frame of a local wireless telephony interface, in accordance with an embodiment;

FIG. 4 shows a signal flow diagram for operations of a local wireless telephony system, in accordance with an embodiment;

FIG. 5 shows a flow chart diagram of a process of operating a local wireless telephony system, in accordance with an embodiment; and

FIG. 6 shows a block schematic diagram of a broadband-enabled device, in accordance with an embodiment.

### DETAILED DESCRIPTION

While the specification concludes with claims defining features that are regarded as novel, it is believed that the claims will be better understood from a consideration of the description in conjunction with the drawings. As required, detailed embodiments are disclosed herein; however, it is to be understood that the disclosed embodiments are merely exemplary. Therefore, specific structural and functional details disclosed herein are not to be interpreted as limiting, but merely as a basis for the claims and as a representative basis for teaching one skilled in the art to variously employ the present subject matter in virtually any appropriately detailed structure. Further, the terms and phrases used herein are not intended to be limiting but rather to provide an understandable description.

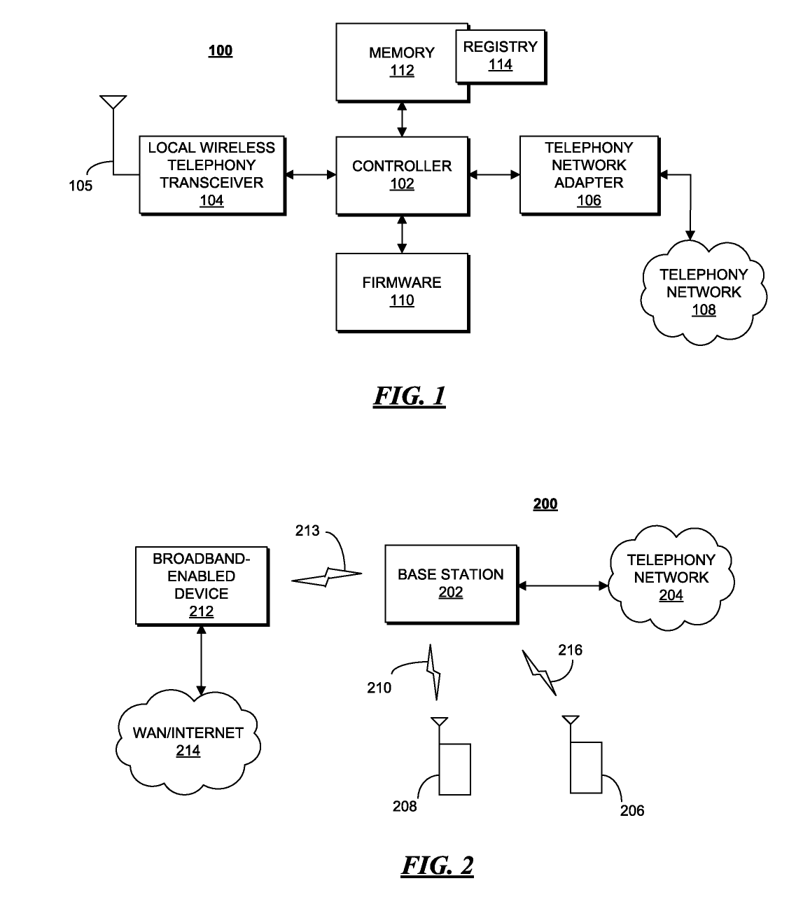

Referring to FIG. 1, there is shown a block schematic diagram of a base station 100 for a local wireless telephony system, in accordance with an embodiment. The base station includes a controller 102 that controls operation of the base station. The controller 102 can be a microprocessor or microcontroller that operates according to instruction code designed in accordance with teachings herein. The controller interfaces with a local telephony transceiver 104 that provides a local wireless telephony interface. The transceiver 104 includes circuitry and components for frequency generation and control, modulation and demodulation, amplification, filtering, and so on, as is well known. The transceiver 104 includes a transmitter for transmitting signals to remote wireless telephony devices, and a receiver for receiving signals from the device. The signals conform to a standardized protocol or air interface that specifies channel characteristics, such as carrier frequency, modulation type, channel bandwidth, timing, and so on. In one embodiment, the local wireless telephony interface can be substantially in conformance with the interface specified by the Digital Enhanced Cordless Telephone (DECT) standard of the European Telephony Standards Institute (ETSI).

The controller 102 is further interfaced with a telephony network adapter 106 to access a telephony network 108. The telephony network 108 can be a public switched telephone network (PSTN), an integrated services digital network (ISDN), private branch exchange network (PBX), or other similar telephony networks. The telephony network adapter 106 is designed to interface with the telephony network 108 and transmit and receive signals to and from, respectively, the telephony network 108. So, for example, if the telephony network 108 uses a POTS interface, the line to the network 108 can be a twisted pair conductor and can use analog signaling, in which case the telephony network adapter 106 should be able to convert digital signals from the base station 100 to appropriate analog signals for the POTS interface, and vice versa.

The controller 102 operates according to instruction code stored in firmware 110, which can be interfaced to the controller 102 via a conventional bus. The firmware 110 is a machine readable storage medium that is non-transitory, meaning that information stored therein persists after power is removed from the memory. The memory can be a read only memory (ROM) or a re-programmable memory, such as an electrically erasable programmable read only memory (EEPROM), or any other such persistent memory. Generally, upon the base station 100 turning on or being powered up, the controller 102 fetches instructions from the firmware 110 and begins executing the instructions.

In the process of executing instructions upon powering up, the controller 102, responsive to the instruction code, can establish certain data structures in a memory 112. The memory 112 is also a machine readable storage medium and can include both volatile and non-volatile memory such as random access memory (RAM), flash memory, and other re-usable memory elements. In addition to runtime variables and other data structure instantiations that can be contained in the memory 112, the memory 112 can also contain a registry 114. The registry 114 contains identifications of remote telephony devices that are registered with the base station. As an example, a device that is registered by the base station can be provided service by the base station 100. The registry can be optionally maintained in firmware memory 110, or in another memory device interfaced with and addressable by the controller 102.

In operation, the base station 100 establishes a local wireless telephony interface via radio communication in the vicinity of the base station 100 to provide both telephony and data service to remote telephony devices that are registered with the base station, as indicated in the registry 114. The base station 100, while having an interface to a telephony network 108, lacks a direct interface with a data services network, such as, for example, the Internet. In order to provide data network connectivity, at least one of the devices registered with the base station 100 should be a broadband-enabled device. A “broadband-enabled device” is defined as a device that can communicate with the base station 100 over the local wireless telephony interface, and which also has a separate interface to a data network.

FIG. 2 shows a system schematic of a local wireless telephony system 200 where data service is relayed to the base station 202 by an associated broadband-enabled device 212, in accordance with an embodiment. The base station 202 can be substantially the same as that illustrated in more detail in FIG. 1, and interfaces with a telephony network 204, which can be substantially the same as telephony network 108 of FIG. 1. The base station 202 provides a local wireless telephony interface to remote telephony devices 206, 208. The telephony network 204 allows calls to be established between parties for real time voice communication, as is known.

The remote telephony devices 206, 208 can alternatively be referred to as handsets and include circuitry and components for receiving user input, graphically displaying information, as well as radio functions for communicating wirelessly with the base station 202. The remote telephony devices 206, 208 are designed to send and receive both digital data and telephony information over the local wireless telephony interface link 210. Generally, the remote telephony devices comprise a microphone for receiving audio acoustic signals from a user, an earpiece speaker for generating acoustic audio signals for a user to hear from corresponding electrical signal, as well as user interface components such as buttons and graphical display elements, and circuitry for controlling and operating such components. The terms “data” and “data traffic” are defined as non-telephony information that is packet based, as opposed to circuit based, and can include content information to be displayed or otherwise perceived by a user, such as images, video, and audio information. Data can also include computer executable code for performing functions on the remote telephony device, including, for example, portable code such as JAVA MIDlets. Data and telephony information, in the context of the present disclosure, are further distinguished by the network over which the respective information types are communicated. Telephony information is communicated over a telephony network 204, while data information is communicated over a data network, such as a wide area network (WAN) 214. A communication over a telephony network can be referred to as a telephone or telephony call, or simply “call.” Telephony networks are circuit switched, whereas data networks are packet based without a particular circuit being established. It will be appreciated by those skilled in the art that applications exist for carrying voice information over data networks, such as voice over internet protocol (VoIP), and since such applications utilize a data network, they are considered to be data under the present disclosure. Other forms of communication can be carried out over the data network as well, such as instant messaging, text-based chat, email, and so on. Furthermore, it is known that data can be transmitted through telephony networks, such as by using dual tone multi-frequency (DTMF) techniques, and since such applications use a telephony network they are considered to be telephony or telephony traffic according to the present disclosure.

To provide service to the remote telephony devices 206, 208, they should first register with the base station 202. By registering, or alternatively stated, subscribing, the base station 202 can permit the remote telephony devices 206, 208 to have access to service facilitated by the base station 202. Unregistered devices may be ignored, except for registration activity. In addition to the remote telephony devices 206, 208, a broadband-enabled device 212 is also registered with the base station 202. The broadband-enabled device 212 communicates with the base station 202 over link 213 of the local wireless telephony interface, and therefore contains some circuitry that is substantially similar to the radio circuitry of remote telephony devices 206, 208. The broadband-enabled device 212 is further interfaced with a broadband data network 214, such as a WAN or the Internet. The broadband-enabled device 212 can be any suitably designed device, including a tablet computing device such as that sold under the trade name OpenFrame, and manufactured by OpenPeak, Inc. of Boca Raton, Fla., as well as a laptop or other computer device, a wireless local area network (WLAN) access point (AP), and so on. The broadband-enabled device 212 can be connected to the data network 214 by conventional means, including a modem, and Ethernet connection, or a wireless connection, for example.

Upon a user of a remote telephony device deciding to initiate a data service activity at the remote telephony device 208, the remote telephony device 208 initiates communication with the base station 202 over a first link 210 of the local wireless telephony interface. The base station 202 recognizes that the remote telephony device 208 is requesting data service access, and initiates communication with the broadband-enabled device 212 over a second link 213 of the local wireless telephony interface. The broadband-enabled device 212 responds and allows access to the data network 214, and the base station 202 routes or relays data between the remote telephony device 208 and the broadband-enabled device 212 for a data session on behalf of the remote telephony device 208. Similarly, the broadband-enabled device 212 routes or relays data between the data network 214 and the base station 202 on behalf of the remote telephony device 208 in order to facilitate a data session between the remote telephony device 208 and some entity in the data network 214. The broadband-enabled device 212 can translate a format of the data between a format used by the local wireless telephony interface and a format used by the data network 214. The base station 202 can be configured to further support telephony activity while also supporting the data session for remote device 208. For example, remote telephony device 206, while remote telephony device 208 is engaged in a data session, can initiate a telephone call over a third link 216 of the local wireless telephony interface with the base station 202. In response, while continuing to support the data session, the base station 202 can connect the second remote device 206 to the telephony network 204 to facilitate the requested telephony connection. Likewise, the data session can be initiated while the base station 202 is presently providing telephony service. It will be appreciated by those skilled in the art that the telephony connection and data session can be initiated by either the same remote telephony device or by different telephony devices. That is, one remote telephony device can engage in both a telephone call and a data session at the same time, allowing a user of the remote telephony device to both speak with others over the telephony network while engaging in data activity.

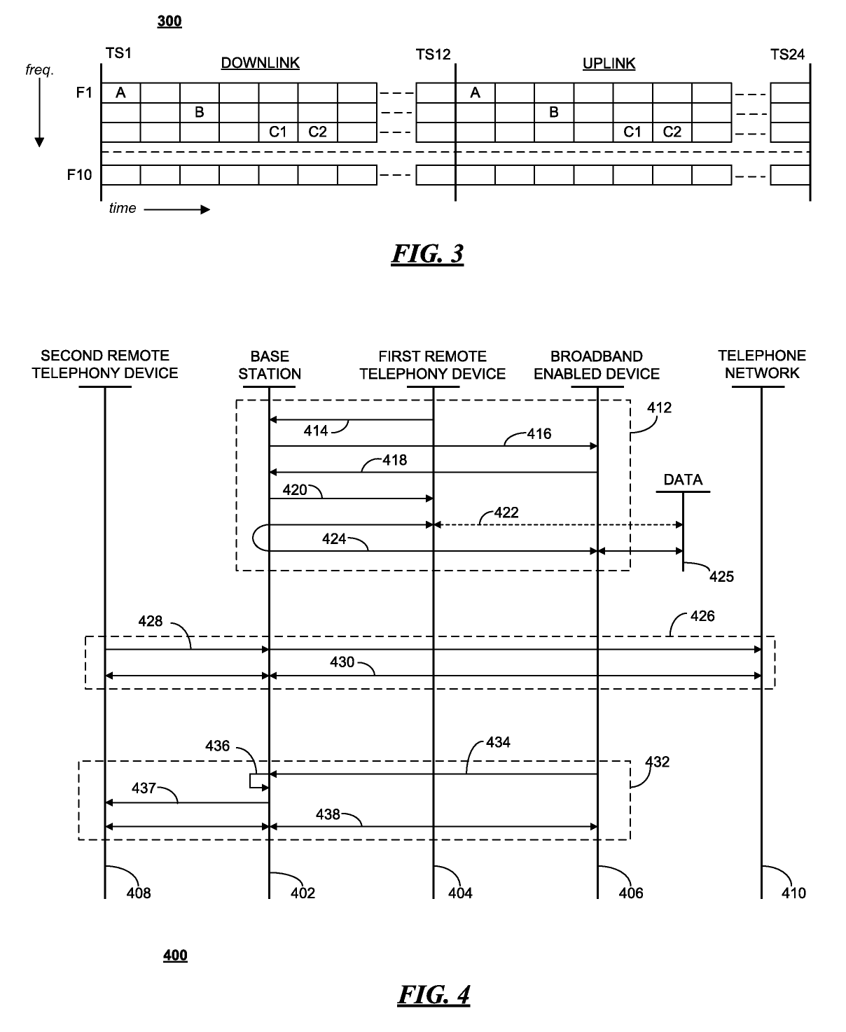

FIG. 3 shows a channel diagram for one frame 300 of a local wireless telephony interface, in accordance with an embodiment. The frame 300 can be a frame of a DECT interface or a local wireless telephony interface substantially in conformance with the DECT interface, however, a variety of local wireless telephony interfaces, standardized or otherwise can be utilized. The present example illustrates how the base station 202 connects to both a remote telephony device 206, 208 and a broadband-enabled device 212 to provide data service to the remote telephony device 206, 208.

The present frame 300 is defined over a time period which is divisioned into 24 time slots, from TS1 to TS24. There are also ten frequency bands F1-F10. The first twelve time slots TS1-TS12 are downlink timeslots, where the base station 202 transmits to registered devices that are presently active. Time slots TS13-TS24 are uplink time slots where the remote devices transmit to the base station. A duplex channel is defined as a one downlink time slot and one uplink time slot pair having corresponding positions in their respective half of the frame. For example, remote device A can operate on a duplex channel defined on frequency F1 using downlink time slot TS1 and uplink time slot TS13. Remote device B can operate on a duplex channel defined on frequency F2 using downlink time slot TS3 and uplink time slot TS15. Either of these channel utilizations can support either a voice call or a data session. For example, remote device A can be engaged in a voice call over a telephony network while remote device B can be engaged in a data session. Each time slot has a defined structure which includes, generally, a header and a payload. The header can include a preamble, synchronization, and payload description information. The payload description can indicate, for example, whether the payload contains telephony voice information, data information, control, or other information. In order to increase data rate, it is contemplated that more than one downlink time slot can be used. For example, remote device C can use more than one downlink time slot, as indicated by downlink assignments C1 and C2, and corresponding uplink time slots C1, C2. When there is no data to be transmitted in a given time slot, downlink or uplink, the payload description can indicate such, and the receiving device can then shut off its receiver to conserve power. As shown here, the base station 202 is connected to three different remote devices A, B, and C, each on different frequencies, but those skilled in the art will recognize that the devices can all use duplex channels on the same frequency band.

FIG. 4 shows a signal flow diagram 400 for operations of a local wireless telephony system, in accordance with an embodiment. The diagram 400 shows the main interactions among a base station 402, a first remote telephony device 404, a broadband-enabled device 406, a second telephony device 408, and a telephony network 410. In a data session setup 412, the first remote telephony device 404 initiates and establishes a data session. Accordingly, the first remote telephony device 404, which can be a wireless or cordless telephone handset, transmits a non-telephony data network access request 414 to the base station 402. The request 414 indicates the first remote telephony device 404 seeks data service, rather than telephone service or some other activity. The request 414 is for the base station, meaning the base station does not forward the request 414, but rather, respond and acts on the request. The request 414 can be transmitting on an uplink time slot or on some other channel means that can be reserved for access requests. The base station 402, in response, forwards the request, or a message indicating a request for data service 416 to the broadband-enabled device 406. The broadband-enabled device 406 can respond 418 to the request from the base station 402, indicating it has the ability presently to facilitate the requested data session. The base station 402 then replies 420 to the first remote telephony device 404 that the request is granted. Upon receiving the request grant 420, the first remote telephony device 404 then commences a data session 422 with a data network 425. The data is routed 424 by the base station 402 and the broadband-enabled device 406. Note, minor signaling such as acknowledgements are not shown in the present example for the sake of clarity, but those familiar with the art will appreciate that such signaling can occur as would be conventional.

In routing the data, the broadband-enabled device 406 extracts data received from the data network 425 from packets, which can be, for example, Internet protocol packets, and repackages the data into the format used by the local wireless telephony interface of the base station 402. Data received from the base station 402 at the broadband-enabled device 406 that is destined to an entity in the data network 425 is likewise reformatted from the local wireless telephony interface format to the data network format. The base station 402, however, does not necessarily reformat data, although it may change header information when routing data from the broadband-enabled device 406 to the first remote telephony device 404, and vice versa. Data received on an uplink time slot from one is simply put into the next frame downlink for the other device.

The data session 424 can be carried on while the base station 402 engages in other activity, including additional data sessions for other remote telephony devices and telephony activity. These other activities can be initiated after the data session 424 is commenced, or the data session 424 can be initiated while the base station is presently supporting a telephone call for another remote telephony device. For example, a second remote telephony device 408 can initiate a telephone call 426 by transmitting conventional telephone signaling 428 to the base station 402. The base station 402 then connects to the telephone network 410 and provides the signaling, such as dialing, to the telephony network interface, and the communication 430 between the remote telephony device and the called party can then commence. The call 426 can be initiated during or before the data session setup 412.

In an embodiment, the broadband-enabled device 406 can operate as a master device. A master device can control aspects of the local wireless telephony system, such as de-registering or de-subscribing other devices, setting options for other devices, engaging in intercom activities where one device calls another device through the base station 402 without network access, among other activities. So, for example, the broadband-enabled device 406, while acting as a master device, can send a command 434 to the base station 402. The command 434 can be any of a variety of commands allowed by a master device, as may be provided by the design of the local wireless telephony system and in particular the base station 402. The command 434 can be, for example, a de-registration command, where, in response to receiving the de-registration command, the base station 402 de-registers 436 the indicated device from the base station registry. In another example, the command 434 can be a command to change an operating or interface feature of a device, such as the second remote telephony device 408. The feature can be, for example, a ringer volume setting, a ring tone selection, or any of a variety of other features. The base station 402 forwards the command 437 to the second remote telephony device, causing the device to make the indicated adjustment. Alternatively, the command 434 can be a command to transfer data to the second remote telephony device 408, such as a ring tone file or an application file. In still a further alternative, an intercom communication 438 can be facilitated by the base station 402 between the broadband-enabled device 406 and the second remote telephony device 408.

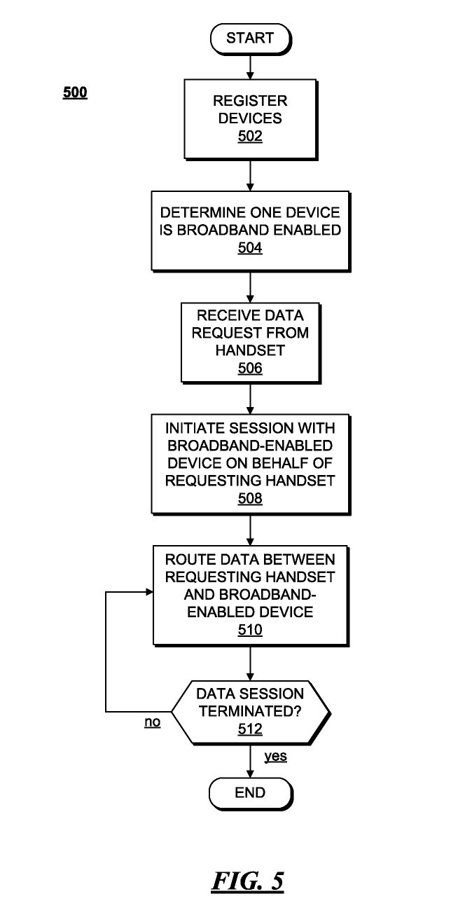

FIG. 5 shows a flow chart diagram of a process 500 of operating a local wireless telephony system, in accordance with an embodiment. The process 500 pictured here may be applicable to the embodiments described above in relation to FIGS. 1-4, but it is understood that the process 500 can be carried out with other suitable systems and arrangements. Moreover, the process 500 may include other steps that are not shown here, and in fact, the process 500 is not limited to including every step shown in FIG. 5. The steps that are illustrated here as part of the process 500 are not limited to this particular chronological order, either.

At the start of the process 500, the local wireless telephony system is powered on and initialized, ready to operate. Preliminarily, a base station can register devices 502. The devices include at least two remote telephony devices, one of which is a broadband-enabled device 504. Upon registering, the broadband-enabled device indicates it has access to a data network, such as Internet connectivity, which is noted by the base station upon registering the broadband-enabled device.

Once the devices are registered, one of the devices can request data access by transmitting a request to the base station 506. The request is received over a first link of the local wireless telephony interface. In response to the request, the base station initiates communication with the broadband-enabled device over a second link of the local wireless telephony interface. The broadband-enabled device initializes a session connection to the data network on behalf of the requesting handset 508. The base station then commences to route data between the requesting handset over the first link and the broadband-enabled device over the second link 510. While the data session commences, the base station also monitors the session to determine if the session has been terminated 512. Once the session is terminated, the process 500 ends.

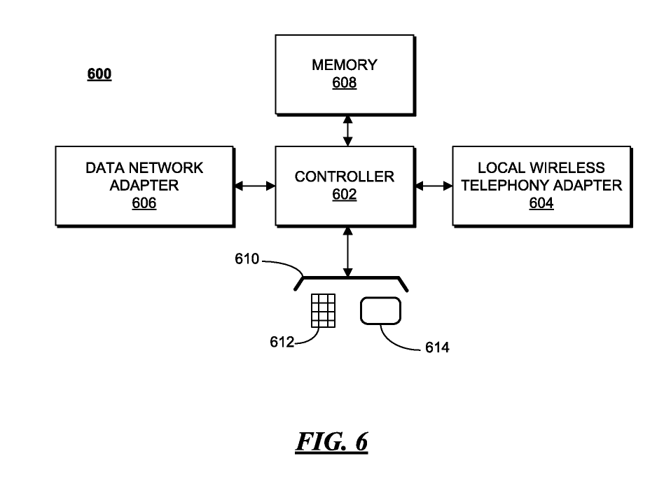

FIG. 6 shows a block schematic diagram of a broadband-enabled device 600, in accordance with an embodiment. The broadband-enabled device 600 comprises a controller 602 which controls operation of the broadband-enabled device 600 according to instruction code that can be stored and executed from a memory 608. The controller 602 can be interface with a local wireless telephony adapter 604 which further interface with a local wireless telephony interface, such as that provided by base station 100 of FIG. 1. As such the local wireless telephony adapter contains radio and logic circuitry for transmitting and receiving signals over the local wireless telephony interface, including frequency generation circuitry, amplifiers, filters, modulation and demodulation circuitry and so on. The logic circuitry allows the local wireless telephony adapter to transmit and receives information digitally over the local wireless telephony interface, and can control timing and synchronization operations of the radio circuitry as well. The controller 602 is further interfaced with a data network adapter 606. The data network adapter 606 can be a wireless of a wired adapter, and contains conventional circuitry for further interfacing with a packet based network, such as, for example, the Internet. The broadband-enabled device 600 can further include user interface elements 610, such as, for example, a keypad 612 or other buttons, and a graphical display 614 for displaying information visually. In some embodiments the graphical display 614 can be a touchscreen display that can receive tactile input from a user.

In operation, the broadband-enabled device 600 can receive a request from a local wireless telephony base station via the local wireless telephony adapter 604 to initiate a data session on behalf of a remote telephony device, although the request may not contain any information specific to the remote telephony device. In response, the broadband-enabled device can contact a network entity via the data network adapter 606. For example, the request received from the base station can include a uniform resource locater (URL) corresponding to a network entity, along with data or other information for network entity. The broadband-enabled device 600 forwards the information to the indicated URL, and receives a response from the network entity, which is forwarded to the base station. In the process of receiving and forwarding information between the data network and the local wireless telephony base station, the broadband-enabled device 600 can translate the format of the data between the format used by the data network and the format used by the local wireless telephony interface.

This description can be embodied in other forms without departing from the spirit or essential attributes thereof. Accordingly, reference should be made to the following claims, rather than to the foregoing specification, as indicating the scope of the invention.

What is claimed is:

1. A method of providing data service to remote telephony devices at a telephony base station, comprising:
receiving a non-telephony data network access request from the remote telephony device at the telephony base station over a first link of a local wireless telephony interface;
forwarding the non-telephony data network access request to a broadband-enabled device over a second link of the local wireless telephony interface responsive to receiving the non-telephony data network access request; and
routing data traffic between the remote telephony device and the broadband-enabled device at the telephony base station using the first and second links of the local wireless telephony interface for a data session established responsive to the non-telephony data network request.

2. The method of claim 1, further comprising:
while routing data traffic between the remote telephony device and the broadband-enabled device at the telephony base station, wherein the remote telephony device is a first remote telephony device, receiving a telephony request from a second remote telephony device over a third link of the local wireless telephony interface;
connecting the second remote telephony device to a telephony network through the telephony base station.

3. The method of claim 1, wherein the remote telephony device is a second telephony device, the method of claim 1 is performed while the telephony base station is providing a connection to telephony service for a first remote telephony device through the telephony base station.

4. The method of claim 1, wherein the local wireless telephony interface conforms substantially to a Digital Enhanced Cordless Telephone (DECT) standard.

5. The method of claim 1, further comprising, prior to performing the method of claim 1, registering the broadband-enabled device with the telephony base station as a device that can also act as a remote telephony device with the telephony base station.

6. The method of claim 5, wherein registering the broadband-enabled device further comprises registering the broadband-enabled device as a master device that is capable of controlling remote telephony devices registered with the telephony base station.

7. The method of claim 1, further comprising:
wherein the remote telephony device is a first remote telephony device and the method further comprises, while routing data traffic between the remote telephony device and the broadband-enabled device, receiving a second non-telephony data network access request from a second remote telephony device at the telephony base station over a first link of a local wireless telephony interface;
forwarding the second non-telephony data network access request to the broadband-enabled device over the local wireless telephony interface responsive to receiving the second non-telephony data network access request; and
routing data traffic between the second remote telephony device and the broadband-enabled device at the telephony base station using the local wireless telephony interface while continuing to route data between the first remote telephony device and the broadband-enabled device.

8. The method of claim 1, further comprising, while routing data traffic between the remote telephony device and the broadband-enabled device, establishing a telephone call from the remote telephony device to a telephone network over a third link of the local wireless telephony interface.

9. A telephony base station of a local wireless telephony system, comprising:
a transceiver that provides a local wireless telephony interface;
a telephony network adapter that interfaces with a telephony network for telephony service;
a registry that maintains registration of devices that communicate with the telephony base station over the local wireless telephony interface, including at least a first remote telephony device and a broadband-enabled device;
wherein, responsive to a non-telephony data network access request from the first remote telephony device, the telephony base station routes data traffic between the remote telephony device and the broadband-enabled device at the telephony base station over the local wireless telephony interface.

10. The telephony base station of claim 9, wherein the local wireless telephony interface conforms substantially to a Digital Enhanced Cordless Telephone (DECT) standard.

11. The telephony base station of claim 9, wherein the telephony base station is operable to allow one of the devices registered with the base station to operate as a master device.

12. The telephony base station of claim 11, wherein the broadband-enabled device is the master device.

13. The telephony base station of claim 9, wherein the base station further facilitates a telephone call between the first remote telephony device and a telephone network while the base station routes data traffic between the remote telephony device and the broadband-enabled device.

14. The telephony base station of claim 9, wherein the base station facilitates a telephone call from a second remote telephony device and a telephone network while the base station routes data traffic between the remote telephony device and the broadband-enabled device.

15. The telephony base station of claim 9, wherein the base station facilitates the broadband-enabled device to operate as a master device in the local wireless telephony system.

16. A method of providing data service access in a local wireless telephony system, comprising:
registering a broadband enabled device with a base station of the local wireless telephony system over a local wireless telephony interface established by the base station;
receiving a request from the base station at the broadband-enabled device to provide data service for a remote telephony device over a first link of the local wireless telephony interface, the remote telephony device connected to the base station over a second link of the local wireless telephony interface;
routing data between a data network via a data connection and the base station via the first link at the broadband enabled device for a data session between the remote telephony device and an entity in the data network.

17. The method of claim 16, wherein routing data between the data network and the base station comprises translating a format of the data between a format used by the local wireless telephony interface and a format used by the data network.

18. The method of claim 16, further comprising initiating a telephone call from the broadband enabled device via the base station over a third link of the local wireless telephony interface between the broadband-enabled device and the base station while routing data between the data network and the base station.

19. The method of claim 16, further comprising operating the broadband-enabled device as a master device of the local wireless telephony system.

20. The method of claim 16, wherein the local wireless telephony interface conforms substantially with a Digital Enhanced Cordless Telephone (DECT) standard.

21. A broadband-enabled device, comprising:
a controller responsive to instruction code of a memory of the broadband-enabled device;
a local wireless telephony adapter operably coupled to the controller; and
a data network adapter operably coupled to the controller;
wherein the broadband-enabled device routes data between a base station of a local wireless telephony system via the local wireless telephony adapter and a network entity of a data network via the data network adapter responsive to a request from the base station.

22. The broadband-enabled device of claim 21, wherein the data network adapter is a wireless data network adapter.

23. The broadband-enabled device of claim 21, wherein the broadband-enabled device translates a format of data between a format used by the data network and a format used by the local wireless telephony system.
